(19) United States
(12) Patent Application Publication
(10) Pub. No.: US 2025/0071621 A1
(43) Pub. Date: Feb. 27, 2025

(54) MANAGING A MULTI-TRAFFIC IDENTIFIER AND MULTI-LINK BLOCK ACKNOWLEDGMENT NEGOTIATION SCHEME

(71) Applicant: QUALCOMM Incorporated, San Diego, CA (US)

(72) Inventors: Alfred ASTERJADHI, San Diego, CA (US); Abhishek Pramod PATIL, San Diego, CA (US); George CHERIAN, San Diego, CA (US); Sai Yiu Duncan HO, San Diego, CA (US); Yanjun SUN, San Diego, CA (US)

(21) Appl. No.: 18/456,416

(22) Filed: Aug. 25, 2023

(51) Int. Cl. H04W 28/20; H04L 5/00

(52) U.S. Cl. CPC H04W 28/20; H04L 5/0053

(57) ABSTRACT

This disclosure provides methods, components, devices and systems for managing a multi-traffic identifier (TID) and multi-link block acknowledgment (BA) negotiation scheme. In some aspects, to negotiate a setup session between wireless communication devices, a first wireless communication device may transmit a request message including an information container that includes one or more negotiation parameter sets each associated with a type of traffic. For example, a type of traffic may correspond to a TID or a resource reservation for a particular traffic flow. Each negotiation parameter set may indicate functionalities being negotiated for the setup session. In association with the negotiation, a second wireless communication device may transmit a response message to the first wireless communication device that includes values for the negotiation parameter sets. For example, the response message may include an acknowledgment (ACK) indicating an acceptance of one or more of the parameter sets for the setup session.

### TECHNICAL FIELD

This disclosure relates to wireless communication and, more specifically, to managing a multi-traffic identifier (TID) and multi-link block acknowledgment (BA) negotiation scheme.

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

Wireless communication devices, such as APs, STAs, and multi-link devices (MLDs), may communicate handshakes, such as four-frame negotiation handshakes to enable communication. For example, a Block Acknowledgment (BA) negotiation may involve a request message, a first corresponding acknowledgment (ACK) message, a response message, and a second corresponding ACK message. The wireless communication devices may perform such four-frame negotiations for each relevant traffic identifier (TID) and for each direction (for example uplink and downlink), which may use significant signaling and power resources, among other disadvantages.

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method for wireless communication by a first wireless communication device. The method may include transmitting, to a second wireless communication device in association with negotiation of a setup session, a request message that includes an information container including one or more negotiation parameter sets, at least one negotiation parameter set of the one or more negotiation parameter sets being associated with a type of traffic and receiving, from the second wireless communication device in association with the negotiation of the setup session and in accordance with the request message, a response message that includes a set of values for one or more of the one or more negotiation parameter sets.

Another innovative aspect of the subject matter described in this disclosure can be implemented in first wireless communication device for wireless communication. The first wireless communication device may include a processing system that includes processor circuitry and memory circuitry that stores code. The processing system may be configured to cause the first wireless communication device to transmit, to a second wireless communication device in association with negotiation of a setup session, a request message that includes an information container including one or more negotiation parameter sets, at least one negotiation parameter set of the one or more negotiation parameter sets being associated with a type of traffic and receive, from the second wireless communication device in association with the negotiation of the setup session and in accordance with the request message, a response message that includes a set of values for one or more of the one or more negotiation parameter sets.

Another innovative aspect of the subject matter described in this disclosure can be implemented in a first wireless communication device for wireless communication. The first wireless communication device may include means for transmitting, to a second wireless communication device in association with negotiation of a setup session, a request message that includes an information container including one or more negotiation parameter sets, at least one negotiation parameter set of the one or more negotiation parameter sets being associated with a type of traffic and means for receiving, from the second wireless communication device in association with the negotiation of the setup session and in accordance with the request message, a response message that includes a set of values for one or more of the one or more negotiation parameter sets.

Another innovative aspect of the subject matter described in this disclosure can be implemented in a non-transitory computer-readable medium storing code for wireless communication. The code may include instructions executable by a processor to transmit, to a second wireless communication device in association with negotiation of a setup session, a request message that includes an information container including one or more negotiation parameter sets, at least one negotiation parameter set of the one or more negotiation parameter sets being associated with a type of traffic and receive, from the second wireless communication device in association with the negotiation of the setup session and in accordance with the request message, a response message that includes a set of values for one or more of the one or more negotiation parameter sets.

In some aspects of the method, first wireless communication devices, and non-transitory computer-readable medium described herein, each of the one or more negotiation parameter sets includes one or more of a block acknowledgement session parameter set including a block ACK action that indicates whether a negotiation parameter set may be associated with the request message or the response message, a dialog token, or one or more negotiation parameters corresponding to each respective TID of one or more TIDs.

In some aspects of the method, first wireless communication devices, and non-transitory computer-readable medium described herein, the one or more negotiation parameters include one or more of a block ACK timeout value, a starting sequence number, or an add block acknowledge extension.

In some aspects of the method, first wireless communication devices, and non-transitory computer-readable medium described herein, each of the one or more negotiation parameter sets includes, for each TID of the one or more TIDs, an aggregation of the one or more negotiation parameters.

In some aspects of the method, first wireless communication devices, and non-transitory computer-readable medium described herein, the at least one negotiation parameter set associated with the type of traffic includes a TID-to-link mapping parameter set.

One innovative aspect of the subject matter described in this disclosure can be implemented in a method for wireless communication by a first wireless communication device. The method may include receiving, from a second wireless communication device in association with negotiation of a setup session, a request message that includes an information container including one or more negotiation parameter sets, at least one negotiation parameter set of the one or more negotiation parameter sets being associated with a type of traffic and transmitting, to the second wireless communication device in association with the negotiation of the setup session and in accordance with the request message, a response message that includes a set of values for one or more of the one or more negotiation parameter sets.

Another innovative aspect of the subject matter described in this disclosure can be implemented in a first wireless communication device for wireless communication. The first wireless communication device may include a processing system that includes processor circuitry and memory circuitry that stores code. The processing system may be configured to cause the first wireless communication device to receive, from a second wireless communication device in association with negotiation of a setup session, a request message that includes an information container including one or more negotiation parameter sets, at least one negotiation parameter set of the one or more negotiation parameter sets being associated with a type of traffic and transmit, to the second wireless communication device in association with the negotiation of the setup session and in accordance with the request message, a response message that includes a set of values for one or more of the one or more negotiation parameter sets.

Another innovative aspect of the subject matter described in this disclosure can be implemented in a first wireless communication device for wireless communication. The first wireless communication device may include means for receiving, from a second wireless communication device in association with negotiation of a setup session, a request message that includes an information container including one or more negotiation parameter sets, at least one negotiation parameter set of the one or more negotiation parameter sets being associated with a type of traffic and means for transmitting, to the second wireless communication device in association with the negotiation of the setup session and in accordance with the request message, a response message that includes a set of values for one or more of the one or more negotiation parameter sets.

Another innovative aspect of the subject matter described in this disclosure can be implemented in a non-transitory computer-readable medium storing code for wireless communication. The code may include instructions executable by a processor to receive, from a second wireless communication device in association with negotiation of a setup session, a request message that includes an information container including one or more negotiation parameter sets, at least one negotiation parameter set of the one or more negotiation parameter sets being associated with a type of traffic and transmit, to the second wireless communication device in association with the negotiation of the setup session and in accordance with the request message, a response message that includes a set of values for one or more of the one or more negotiation parameter sets.

In some aspects of the method, first wireless communication devices, and non-transitory computer-readable medium described herein, each of the one or more negotiation parameter sets includes one or more of a block acknowledgement session parameter set including a block ACK action that indicates whether a negotiation parameter set may be associated with the request message or the response message, a dialog token, or one or more negotiation parameters corresponding to each respective TID one or more TIDs.

In some aspects of the method, first wireless communication devices, and non-transitory computer-readable medium described herein, the one or more negotiation parameters include one or more of a block ACK timeout value, a starting sequence number, or an add block acknowledge extension.

In some aspects of the method, first wireless communication devices, and non-transitory computer-readable medium described herein, each of the one or more negotiation parameter sets includes, for each TID of the one or more TIDs, an aggregation of the one or more negotiation parameters.

In some aspects of the method, first wireless communication devices, and non-transitory computer-readable medium described herein, the at least one negotiation parameter set associated with the type of traffic includes a TID-to-link mapping parameter set.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows a pictorial example of an example process that supports managing a multi-traffic identifier (TID) and multi-link block acknowledgment (BA) negotiation scheme.

FIGS. 3 and 4 show examples of field formats that support managing a multi-TID and multi-link BA negotiation scheme.

FIG. 5 shows an example of a process flow that supports managing a multi-TID and multi-link BA negotiation scheme.

FIGS. 6 and 7 show block diagrams of devices that support managing a multi-TID and multi-link BA negotiation scheme in accordance with one or more aspects of the present disclosure.

FIG. 8 shows a block diagram of an example wireless communication device that supports managing a multi-TID and multi-link BA negotiation scheme.

FIG. 9 shows a diagram of a system including a device that supports managing a multi-TID and multi-link BA negotiation scheme in accordance with one or more aspects of the present disclosure.

FIGS. 10 through 13 show flowcharts illustrating example processes performable by or at a first wireless communication device that supports managing a multi-TID and multi-link BA negotiation scheme.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described examples can be implemented in any device, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IoT) network.

Some wireless communication devices may communicate handshakes, such as four-frame negotiation handshakes to enable communications. For example, a Block Acknowledgment (BA) negotiation may involve a request message, a first corresponding acknowledgment (ACK) message, a response message, and a second corresponding ACK message to negotiate some BA communications between the wireless communication devices. The wireless communication devices may perform such four-frame negotiation handshakes for each relevant traffic identifier (TID) and for each link (and direction, for example, uplink and downlink) associated with the communications. For example, if the wireless communication devices support eight TIDs, the wireless devices may perform up to 16 of the four-frame negotiation handshakes, which may use significant signaling and power resources. In addition, to renegotiate the setup session (for example, if parameters change or are updated for one or more TIDs), the wireless communication devices may restart the setup session negotiation for all of the TIDS.

Various aspects relate generally to a negotiation procedure for a multi-TID and multi-link BA setup session for communications between two wireless communication devices. Some aspects more specifically relate to a negotiation of a multi-TID, multi-link, BA setup session, the setup session including an exchange of a set of frames to establish the communications between the wireless communication devices. For example, as part of the negotiation of a setup session between a first wireless communication device and a second wireless communication device (which may each be an example of an access point (AP) or a station (STA), among other examples), the first wireless communication device may transmit a request message to the second wireless communication device that includes an information container (an information element). The information container may include one or more negotiation parameter sets (for example, BA session parameter sets for a BA setup session) including fields and/or parameters that indicate one or more functionalities being negotiated for the setup session. At least one negotiation parameter set of the one or more negotiation parameter sets may be associated with a type of traffic, for example, a TID or a traffic flow, which may enable the wireless communication devices to negotiate the setup session on a per-TID basis. For example, a negotiation parameter set may be or include a TID-to-link mapping parameter set that indicates a mapping between one or multiple TIDs and one or multiple respective links associated with the setup session. The one or more negotiation parameter sets (and in some aspects, other information or elements in the information container) may differ based on a particular session type. As part of the negotiation, the second wireless communication device may transmit a response message to the first wireless communication device that includes a set of values for one or more of the one or more negotiation parameter sets, which the wireless communication devices may use for future BA sessions. In some implementations, the response message may include an ACK indicating an acceptance of one or more of the negotiation parameter sets for the setup session (for example, a negotiation parameter set for each TID of a set of TIDs).

Particular aspects of the subject matter described in this disclosure can be implemented to realize one or more of the following potential advantages. For example, a first wireless communication device may transmit a message including an information container that indicates parameter sets for a setup session negotiation and TID-to-link mapping The information container may enable the first wireless communication device to negotiate the setup session for communications with a second wireless communication device using fewer messages, which may reduce negotiation signaling overhead and increase power savings. For example, instead of performing a four-frame handshake for each TID and link associated with the setup session, the information container may reduce the signaling to one four-frame handshake or one three-frame handshake (in some circumstances) for a set of multiple supported TIDs. Moreover, the request message and the response message addressing the one or more negotiation parameter sets on a per-TID basis may enable the first wireless communication device to update or renegotiate the session setup for specific TIDs (instead of the entire set of multiple TIDs). By leveraging the information container to negotiate and renegotiate parameters for the session setup on a per-TID basis, the wireless communication device may utilize aspects of the described subject matter to further improve reliability, improve user experience, and/or increase system capacity, among other benefits.

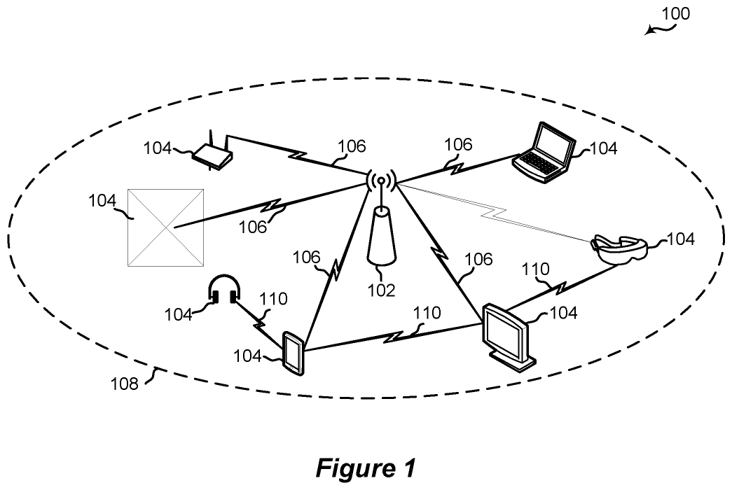

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards (such as defined by the IEEE 802.11-2020 specification or amendments thereof including, but not limited to, 802.11ay, 802.11ax, 802.11az, 802.11ba, 802.11bd, 802.11be, 802.11bf, and 802.11bn). In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core.

The wireless communication network 100 may include numerous wireless communication devices including at least one wireless AP (AP) 102 and any number of wireless STAs (STAs) 104. While only one AP 102 is shown in FIG. 1, the wireless communication network 100 can include multiple APs 102. The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP MLD (MLD)), as well as cellular (such as 3GPP, 4G LTE, 5G or 6G) base STAs or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile STA (MS), a mobile device, a mobile handset, a wireless handset, an access terminal (AT), a user equipment (UE), a subscriber STA (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHZ, 5 GHZ, 6 GHz, 45 GHZ, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some cases, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some cases, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communication (hereinafter also referred to as “Wi-Fi communication” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the WLAN wireless communication network 100 may transmit PPDUs over an unlicensed spectrum, which may be a portion of spectrum that includes frequency bands traditionally used by Wi-Fi technology, such as the 2.4 GHZ, 5 GHZ, 6 GHZ, 45 GHZ, and 60 GHz bands. Some aspects of the APs 102 and STAs 104 described herein also may communicate in other frequency bands that may support licensed or unlicensed communication. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHZ-7.125 GHZ), FR2 (24.25 GHZ-52.6 GHZ), FR3 (7.125 GHZ-24.25 GHZ), FR4a or FR4-1 (52.6 GHZ-71 GHZ), FR4 (52.6 GHZ-114.25 GHZ), and FR5 (114.25 GHZ-300 GHZ).

Each of the frequency bands may include multiple sub-bands and frequency channels (also referred to as subchannels). For example, PPDUs conforming to the IEEE 802.11n, 802.11ac, 802.11ax, 802.11be and 802.11bn standard amendments may be transmitted over one or more of the 2.4 GHZ, 5 GHZ, or 6 GHZ bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHZ, 80 MHZ, 160 MHZ, 240 MHZ, 320 MHz, 480 MHz, or 640 MHz by bonding together multiple 20 MHz channels.

In some aspects, the AP 102 or the STAs 104 of the wireless communication network 100 may implement Extremely High Throughput (EHT) or other features compliant with current and future generations of the IEEE 802.11 family of wireless communication protocol standards (such as the IEEE 802.11be and 802.11bn standard amendments) to provide additional capabilities over other previous systems (for example, High Efficiency (HE) systems or other legacy systems). For example, the IEEE 802.11be standard amendment introduced 320 MHz channels, which are twice as wide as those possible with the IEEE 802.11ax standard amendment. Accordingly, the AP 102 or the STAs 104 may use 320 MHz channels enabling double the throughput and network capacity, as well as providing rate versus range gains at high data rates due to linear bandwidth versus log SNR trade-off. EHT and newer wireless communication protocols (such as the protocols referred to as or associated with the IEEE 802.11bn standard amendment) may support flexible operating bandwidth enhancements, such as broadened operating bandwidths relative to legacy operating bandwidths or more granular operation relative to legacy operation. For example, an EHT system may allow communication spanning operating bandwidths of 20 MHz, 40 MHZ, 80 MHZ, 160 MHz, 240 MHZ, and 320 MHz. EHT systems may support multiple bandwidth modes such as a contiguous 240 MHz bandwidth mode, a contiguous 320 MHz bandwidth mode, a noncontiguous 160+160 MHz bandwidth mode, or a noncontiguous 80+80+80+80 (or “4×80”) MHz bandwidth mode.

In some aspects in which a wireless communication device (such as the AP 102 or the STA 104) operates in a contiguous 320 MHz bandwidth mode or a 160+160 MHz bandwidth mode, signals for transmission may be generated by two different transmit chains of the wireless communication device each having or associated with a bandwidth of 160 MHZ (and each coupled to a different power amplifier). In some other examples, two transmit chains can be used to support a 240 MHz/160+80 MHZ bandwidth mode by puncturing 320 MHz/160+160 MHz bandwidth modes with one or more 80 MHz subchannels. For example, signals for transmission may be generated by two different transmit chains of the wireless communication device each having a bandwidth of 160 MHz with one of the transmit chains outputting a signal having an 80 MHz subchannel punctured therein. In some other examples in which the wireless communication device may operate in a contiguous 240 MHz bandwidth mode, or a noncontiguous 160+80 MHz bandwidth mode, the signals for transmission may be generated by three different transmit chains of the wireless communication device, each having a bandwidth of 80 MHz. In some other examples, signals for transmission may be generated by four or more different transmit chains of the wireless communication device, each having a bandwidth of 80 MHZ.

In noncontiguous examples, the operating bandwidth may span one or more disparate sub-channel sets. For example, the 320 MHz bandwidth may be contiguous and located in the same 6 GHz band or noncontiguous and located in different bands or regions within a band (such as partly in the 5 GHz band and partly in the 6 GHz band).

In some aspects, the AP 102 or the STA 104 may benefit from operability enhancements associated with EHT and newer generations of the IEEE 802.11 family of wireless communication protocol standards. For example, the AP 102 or the STA 104 attempting to gain access to the wireless medium of wireless communication network 100 may perform techniques (which may include modifications to existing rules, structure, or signaling implemented for legacy systems) such as clear channel assessment (CCA) operation based on EHT enhancements such as increased bandwidth, puncturing, or refinements to carrier sensing and signal reporting mechanisms.

Retransmission protocols, such as hybrid automatic repeat request (HARQ), also may offer performance gains. A HARQ protocol may support various HARQ signaling between transmitting and receiving wireless communication devices (for example, the AP 102 and the STAs 104 described with reference to FIG. 1) as well as signaling between the PHY and MAC layers to improve the retransmission operations in a WLAN. HARQ uses a combination of error detection and error correction. For example, a HARQ transmission may include error checking bits that are added to data to be transmitted using an error-detecting (ED) code, such as a cyclic redundancy check (CRC). The error checking bits may be used by the receiving device to determine if it has properly decoded the received HARQ transmission. In some aspects, the original data (information bits) to be transmitted may be encoded with a forward error correction (FEC) code, such as using a low-density parity check (LDPC) coding scheme that systematically encodes the information bits to produce parity bits. The transmitting device may transmit both the original information bits as well as the parity bits in the HARQ transmission to the receiving device. The receiving device may be able to use the parity bits to correct errors in the information bits, thus avoiding a retransmission.

Implementing a HARQ protocol in a WLAN may improve reliability of data communicated from a transmitting device to a receiving device. The HARQ protocol may support the establishment of a HARQ session between the two devices. Once a HARQ session is established, if a receiving device cannot properly decode (and cannot correct the errors) a first HARQ transmission received from the transmitting device, the receiving device may transmit a HARQ feedback message to the transmitting device (for example, a negative acknowledgement (NACK)) that indicates at least part of the first HARQ transmission was not properly decoded. Such a HARQ feedback message may be different than the traditional Block ACK feedback message type associated with conventional ARQ. In response to receiving the HARQ feedback message, the transmitting device may transmit a second HARQ transmission to the receiving device to communicate at least part of further assist the receiving device in decoding the first HARQ transmission. For example, the transmitting device may include some or all of the original information bits, some or all of the original parity bits, as well as other, different parity bits in the second HARQ transmission. The combined HARQ transmissions may be processed for decoding and error correction such that the complete signal associated with the HARQ transmissions can be obtained.

In some aspects, the receiving device may be enabled to control whether to continue the HARQ process or revert to a non-HARQ retransmission scheme (such as an automatic repeat request (ARQ) protocol). Such switching may reduce feedback overhead and increase the flexibility for retransmissions by allowing devices to dynamically switch between ARQ and HARQ protocols during frame exchanges. Some implementations also may allow multiplexing of communication that employ ARQ with those that employ HARQ.

Wireless communication devices, such as APs 102, STAs 104, and multi-link devices (MLDs), may communicate four-frame negotiation handshakes. For example, a BA negotiation may involve a request message, a corresponding ACK message, a response message, and another corresponding ACK message. The wireless communication devices may perform such four-frame negotiations for each relevant TID and for each direction (for example uplink and downlink), which may use significant amounts of signaling overhead and power.

In accordance with examples described herein, wireless communication devices (for example APs 102, STAs 104, MLDs, among other examples) may support a negotiation procedure for a multi-TID multi-link setup session. For example, during the negotiation of a setup session between a first wireless communication device and a second wireless communication device, the first wireless communication device may transmit a request message including an information container (for example, an information element). The request message may include one or more negotiation parameter sets (for example, BA session parameter sets) including fields and/or parameters that indicate one or more functionalities being negotiated for the setup session. At least one negotiation parameter set of the one or more negotiation parameter sets may be associated with (or for) a type of traffic, for example, a TID or a traffic flow, which may enable the wireless communication devices to negotiate the setup session on a per-TID basis. For example, a negotiation parameter set may be a TID-to-link mapping parameter set that indicates a mapping between one or multiple TIDs and one or more respective links associated with the setup session.

As part of the negotiation, the second wireless communication device may transmit a response message to the first wireless communication device that includes one or more values for one or more of the negotiation parameter sets. For example, the response message may include an ACK indicating an acceptance of one or more of the negotiation parameter sets for the setup session.

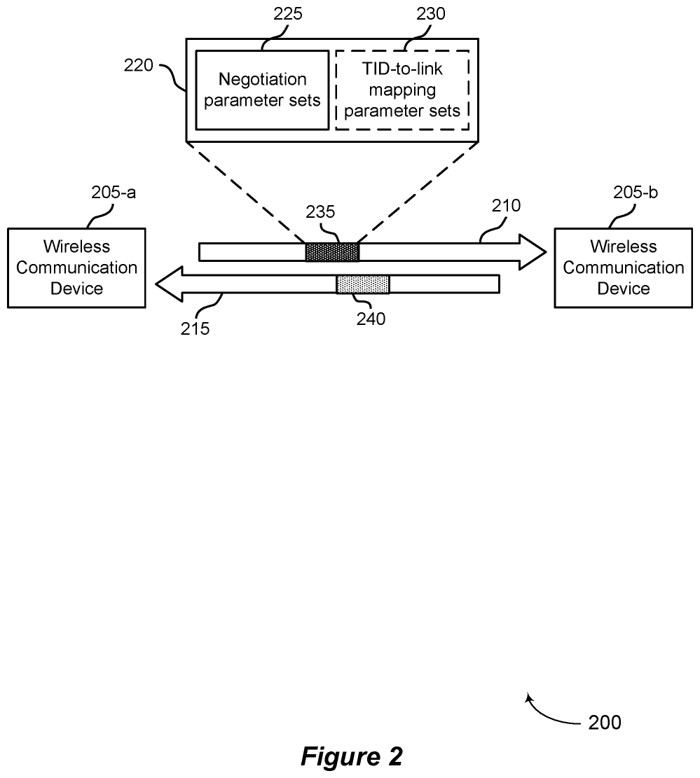

FIG. 2 shows a pictorial example of an example process 200 performable by a wireless communication device that supports managing a multi-TID and multi-link BA negotiation scheme. The example process 200 may implement aspects of the wireless communication network 100 or may be implemented by aspects of the wireless communication network 100. For example, the example process 200 may include a wireless communication device 205-a and a wireless communication device 205-b, which may be examples of corresponding devices described herein. For examples, a wireless communication device 205 may be an AP 102 or a STA 104, or a wireless communication device 205 may be an MLD (including multiple APs 102 or multiple STAs 104). The wireless communication device 205-a may communicate with the wireless communication device 205-b via the communication link 210 and the communication link 215. The communication link 210 and the communication link 215 may support uplink or downlink communication and/or in some implementations, may be a sidelink connection. A device transmitting a signal (for example, a message in the uplink, downlink, or sidelink) may be referred to as a transmitting device, and a device receiving the signal (for example, in the uplink, downlink, or sidelink) may be referred to as a receiving device.

The example process 200 may implement different types of negotiation procedures after device association to allocate sufficient memory and resources to a particular functionality. For example, the wireless communication devices 205 may negotiate baseline BA setup sessions on a per-TID basis, which may begin after successful exchanges of Add Block Acknowledge (ADDBA) request and response messages. In such cases, a transmitting device (for example a UE, a network entity) may indicate parameter preferences, and a receiving device (for example a UE, a network entity) may acknowledge or decline the parameters. In examples in which the wireless communication system is a UHR Wi-Fi system, the wireless communication devices 205 may experience a higher achievable throughput (for example, an increase of bandwidth to 480 MHz, higher QAM constellations, among other parameter increases) and enhancements to multi-link operations and multi-AP coordination. In addition, such exchanges may result in expected buffer size increments of up to 1024 or more and may involve (for BA setup sessions) TID mapping to different links, different APs, or other components.

In some aspects, STAs 104 may perform BA negotiation with two action frames including ADDBA request an ADDBA response exchanges (a handshake). Each frame may include a set of BA session parameters for the originating STA 104 and a set of parameters agreed to (if accepted) by the recipient STA 104. In such cases, one handshake may be required for each BA setup (for example, a tuple consisting of <receiver address (RA), transmitter address (TA), TID>). Some wireless communication systems may support up to 16 BA setup sessions between two peer devices, one per TID and per direction (for example, <STA, AP, TID0-TID7> and (AP, STA, TID0-TID7>). Each BA setup session may include at least one set of ADDBA request and ADDBA response exchanges, including four frames per handshake (including an ACK). The STAs 104 may use more frame exchanges in examples in which re-negotiations are initiated.

In accordance with examples described herein, a negotiation scheme may be implemented for multi-TID and multi-link BA setup sessions to reduce signaling overhead and increase flexibility of the negotiation procedure. A multi-TID, multi-link BA setup session may include an exchange of a set of frames to establish communications between the wireless communication devices 205 for a subsequent BA session. For example, the wireless communication devices 205 may exchange capability information to indicate whether the wireless communication device 205-b supports the BA session. In addition, the wireless communication devices 205 may support multi-TID BA session negotiations and TID-to-link mapping while negotiating the BA sessions, which may accelerate the negotiation process in case of disagreements between the wireless communication devices 205. That is, in addition to negotiating a multi-TID, multi-link BA setup session, the wireless communication devices 205 may negotiate a subsequent multi-TID, multi-link BA session using the techniques described herein to reduce signaling overhead and power consumption.

The wireless communication device 205-a may create an information container 220 (also referred to herein as an information element) that includes one or more negotiation parameter sets 225 (for example, BA parameter sets). The wireless communication device 205-a may transmit the information container 220 to the wireless communication device 205-b within a request message 235 and in association with negotiation of a setup session (for example, during negotiation of a BA setup session).

In some implementations, at least one negotiation parameter set of the one or more negotiation parameter sets 225 may be associated with a type of traffic or for a particular type of traffic. The wireless communication device 205 may identify the type of traffic based on an access category, a TID, or other means, and the negotiation for the particular type of traffic may include at least one of TID-to-link mapping, medium reservation for a traffic flow, or prioritization or de-prioritization of transmissions for the traffic flow. For example, the type of traffic may correspond to a TID, where the wireless communication devices 205 may perform negotiation of the setup session for a particular TID. In such aspects, the one or more negotiation parameter sets 225 may be or may include one or more TID-to-link mapping parameter sets 230 for the particular TID. Additionally, or alternatively, the one or more negotiation parameter sets 225 may indicate a resource reservation for a particular traffic flow.

Each of the one or more negotiation parameter sets 225 may include an action (a BA action) that differentiates an ADDBA request from an ADDBA response. That is, an action may indicate whether the information container 220 is included in a request or a response to a particular request. In addition, each of the one or more negotiation parameter sets 225 may include a dialog token (which may be excluded in examples in which the element is included in an action frame given that the action frame may carry a field for the dialog token), and one or more negotiation parameters for each TID of a set of TIDs associated with the setup session.

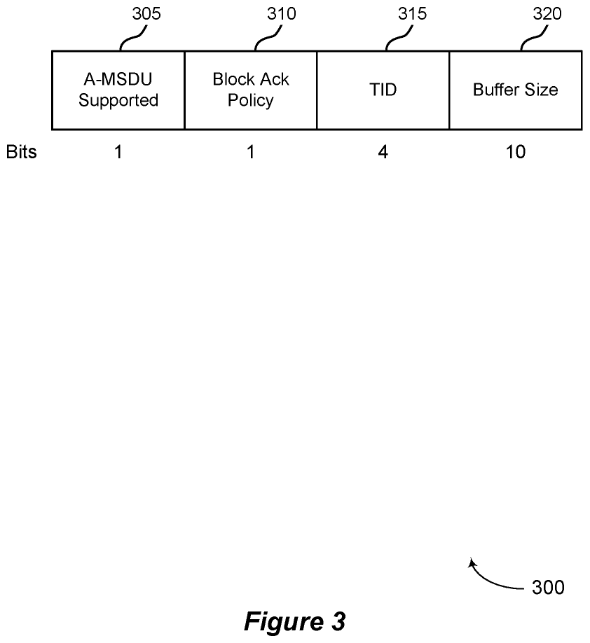

The one or more negotiation parameters may be related to the BA negotiation and may include, for example, a BA timeout value, a starting sequence number, and an ADDBA extension, among other parameters. In some aspects, an ADDBA extension may indicate additional functionalities that may be negotiated for the TID, including functionalities related to fragmentation. The information container 220 may identify a TID for which each of the one or more negotiation parameter sets 225 may be applicable, such that each of the one or more negotiation parameter sets 225 may include an aggregation of the one or more negotiation parameters for each TID. In some implementations, each of the one or more negotiation parameter sets may include parameters proactively provided to aid the wireless communication device 205-b in selecting appropriate values for one or more of the one or more negotiation parameter sets 225 it intends to include in a request message 235. Additional details regarding the one or more negotiation parameter sets 225 are described herein with reference to FIG. 3.

In addition, each of the one or more TID-to-link mapping parameter sets 230 may indicate one or more links to which a TID maps. That is, each of the one or more TID-to-link mapping parameter sets 230 may indicate a mapping between each TID of the one or more TIDs and the one or more links. For example, each TID may map to a set of one or more links for uplink communication and a set of one or more links for downlink communication. The set of one or more links being mapped may be same links via which the frame communication occurs or different links. In some aspects, the information container 220 may exclude the one or more TID-to-link mapping parameter sets 230 as the setup session may be TID-agnostic. In such cases, the wireless communication device 205-a may refrain from indicating the one or more TID-to-link mapping parameter sets 230 or include the one or more TID-to-link mapping parameter sets 230 in later signaling.

In accordance with the request message 235, and in association with the negotiation of the setup session, the wireless communication device 205-b may transmit a response message 240. The response message 240 may include a set of values for one or more of the one or more negotiation parameter sets 225 (or in some aspects, the one or more TID-to-link mapping parameter sets 230). For example, the response message 240 may indicate an ACK of each (or a subset of) the one or more negotiation parameter sets 225 (acknowledging acceptance of the parameters by the wireless communication device 205-b). In some aspects, the wireless communication device 205-b may indicate a separate status indicator for each of the one or more negotiation parameter sets 225 and for each type of traffic or TID. For example, in the case of BA session setup negotiation, the wireless communication device 205-b may include a status indicator (for example, a bit) for each TID to indicate whether a given parameter set of the one or more negotiation parameter sets 225 is a success (acknowledged) or a failure.

In some aspects, the wireless communication device 205-a may authenticate the wireless communication device 205-b during an association procedure to insure that the wireless communication device 205-b is genuine. For example, the wireless communication device 205-a may transmit an authentication message to the wireless communication device 205-b for authenticating the wireless communication device 205-b. The wireless communication device 205-a may transmit the information container 220 in accordance with the authentication message.

In some implementations, the wireless communication device 205-a may include an ADDBA parameter set element (of the information container 220) in an association request frame transmitted during the association phase. In such cases, the information container 220 may indicate a list of TIDs for which the wireless communication device 205-a is transmitting the request message 235 (a BA setup request), one or more corresponding negotiation parameters, and in some implementations, the one or more TID-to-link mapping parameter sets 230. In addition, within the association request frame, the information container 220 may include one or more default negotiation parameter sets (for example, one or more default BA parameter sets) and one or more default TID-to-link mapping parameter sets. The default parameter sets may be equivalent to a non-AP MLD's preferred parameter set in examples in which the non-AP MLD were to respond to an ADDBA request from an AP MLD. The default parameter sets may be based on capabilities of the wireless communication devices 205 (that is, the wireless communication devices 205 may support the default parameters). The wireless communication device 205-b may accept the association, thus accepting the session setup that is being negotiated. In some aspects, the wireless communication device 205-a may respond to the wireless communication device 205-a indicating acceptance of a subset of the default parameter sets (for example, based on a memory limitation). By indicating the default parameter sets, the wireless communication devices 205 may quickly agree (converge) on mutually agreeable parameter sets, therefore reducing the chance of disagreement and further exchange of frames. In addition, this may enable the wireless communication devices 205 to negotiate BA setup sessions during or after association for multiple TIDs and multiple links with a single handshake.

The wireless communication devices 205 may perform the setup session negotiation after the association phase and in some implementations, an authentication procedure. In accordance with the setup session negotiation, the wireless communication devices 205 may communication action frames (for example, ADDBA request and response frames), which may carry the information container 220. An ADDBA request frame action field format may include information described in Table 1.

TABLE 1
ADDBA request frame action field format

| Order | Information |
|---|---|
| 1 | Category |
| 2 | Block Ack Action |
| 3 | Dialog Token |
| 4 | Block Ack Parameter Set |
| 5 | Block Ack Timeout Value |
| 6 | Block Ack Starting Sequence Control |
| 7 | GroupCast with Retries (GCR) Group |
| | Address Element (optional) |
| 8 | Multi-band (optional) |
| 9 | Traffic Classification (TCLAS) (optional) |
| 10 | ADDBA Extension (optional) |

In such implementations, the information container 220 in the ADDBA request frame (as described herein with reference to Table 1) may signal the session setup (a BA setup) for multiple TIDs and provide the TID mapping for multiple TIDs (via the one or more TID-to-link mapping parameter sets 230). In response to the ADDBA request frame, the wireless communication device 205-b may transmit an ADDBA response frame to indicate the set of values for one or more of the one or more negotiation parameter sets 225 or the one or more TID-to-link mapping parameter sets 230. For example, in addition to the information described herein with respect to Table 2, the ADDBA response frame may indicate an ACK to one or more of the parameters.

TABLE 2
ADBA response frame action field format

| Order | Information |
|---|---|
| 1 | Category |
| 2 | Block Ack Action |
| 3 | Dialog Token |
| 4 | Block Ack Parameter Set |
| 5 | Block Ack Timeout Value |
| 6 | Block Ack Starting Sequence Control |
| 7 | GCR Group Address Element (optional) |
| 8 | Multi-band (optional) |
| 9 | TCLAS (optional) |
| 10 | ADDBA Extension (optional) |
| 11 | Originator Preferred MCS (optional) |

The wireless communication device 205-a may use the ADDBA request and response framework described herein to establish or renegotiate a session setup (a BA setup) for a specific TID rather than reinitiating the session setup for each of the one or more TIDs via serial exchanges. For example, in association with the renegotiation of the setup session, the wireless communication device 205-a may transmit a second (updated) request message including an information container 220, the information container 220 including one or more second (updated) negotiation parameter sets each being associated with a type of traffic (for example, a TID, a traffic flow). The wireless communication device 205-b may transmit a second (updated) response message including a second (updated) set of values for one or more of the parameter sets. That is, the wireless communication devices 205 may utilize a single ADDBA exchange (including four frames) to establish or update a session setup, TID mapping, or both for multiple TIDs.

In some aspects, the wireless communication device 205-a may indicate a set of parameters that may be acceptable (or preferred) to the wireless communication device 205-a in examples in which the wireless communication device 205-b were to include the set of parameters in a request while initiating the session setup. The wireless communication device 205-a may piggyback an indication of the acceptable set of parameters on the request message 235 indicating the one or more negotiation parameter sets 225 in the information container 220. For example, via the request message 235, the wireless communication device 205-a may transmit one or more negotiation parameter sets acceptable to the wireless communication device 205-a for the negotiation of the setup session (BA setup session). In response to the request message 235, the wireless communication device 205-b may transmit a second request message including a second information container 220, the second information container 220 including the one or more negotiation parameter sets acceptable to the wireless communication device 205-a.

The wireless communication devices 205 may communicate the information container 220 for different negotiation protocols, such as a target-wake-time (TWT) negotiation. That is, the information container 220 may be a generic container information element that may be defined to carry variable information (as sub-elements) depending on a negotiation type associated with the setup session. For example, the information container 220 may carry BA parameters and TID-mapping information for a BA session setup, as described herein. Alternatively, the information container 220 may carry TWT parameters and link information (if multi-link TWT is enabled) for a TWT setup. In some aspects, the techniques described herein may be applicable to one or more of roaming related protocols, multi-link protocols (for example, reconfigurations, adding or removing links), multi-AP protocols, or relay settings (for example, relay STA aggregated BA information of satellite STAs along with its own BA information). In addition, the described techniques may support mixing and matching of request and response messages in a same action frame, which may be added in the authentication request and response frames. For example, the example process 200 may support the information container 220 indicating parameters for TIDS 1-7 in the request message 235 and indicating parameters for TIDs 8-16 in the response message 240.

FIG. 3 shows an example of a field format 300 that supports managing a multi-TID and multi-link BA negotiation scheme. In some aspects, the field format 300 may implement aspects of the wireless communication network 100 and the example process 200 or may be implemented by aspects of the wireless communication network 100 and the example process 200. For example, the field format 300 may represent an example of a BA parameter set field format, which may be included in an information container 220 as described herein with reference to FIG. 2.

As described herein with reference to FIG. 2, a wireless communication device (an STA, an AP, an MLD) may transmit a request message indicating an information container, the information container including a set of one or more negotiation parameter sets (BA session parameter sets, one or more negotiation parameter sets 225 described herein with reference to FIG. 2). Each of the one or more negotiation parameter sets may include the field format 300, which may include an aggregated-MAC service data unit (A-MSDU) supported field 305 (one bit), a BA policy field 310 (one bit), a TID field 315 (up to four bits), and a buffer size field (up to 10 bits). In addition, a negotiation parameter set of the one or more negotiation parameter sets may be associated with or indicated for a type of traffic such as a TID or a traffic flow. For example, a negotiation parameter set may be or may be associated with a TID-to-link mapping parameter set (one o more TID-to-link mapping parameter sets described herein with reference to FIG. 2). In some aspects, the A-MSDU supported field 305 may be set to a value of 1 to indicate that the transmitting device supports an A-MSDU under the session setup negotiation. The BA policy field 310 may indicate a type of BA policy supported for the setup session. The TID field 315 may indicate a TID associated with the BA parameter set indicated via the field format, and the buffer size field 320 may indicate an amount of buffer available for the particular TID indicated in the TID field 315.

The field format 300 may be included in ADDBA request or response frames to signal the parameters for establishing a BA agreement (the BA session setup negotiation). In accordance with the aspects described herein, the information container may include an aggregation of parameter sets according to the field format 300 for each TID of a set of TIDs associated with the session setup. In some aspects, the field format 300 may include an additional action field to identify whether the information container is associated with a request message or a response message.

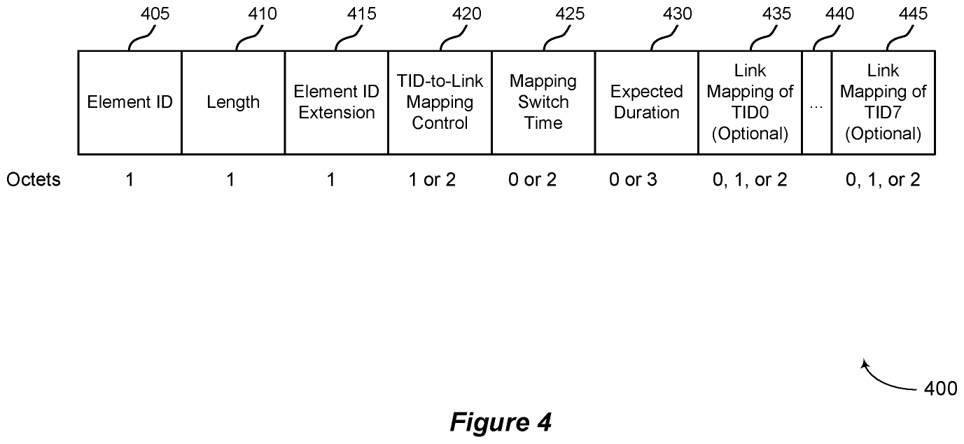

FIG. 4 shows an example of a field format 400 that supports managing a multi-TID and multi-link BA negotiation scheme. In some aspects, the field format 400 may implement aspects of the wireless communication network 100 and the example process 200 or may be implemented by aspects of the wireless communication network 100 and the example process 200. For example, the field format 400 may represent an example of a TID-to-link mapping element format, which may be included in an information container 220 as described herein with reference to FIG. 2.

As described herein with reference to FIG. 2, a wireless communication device (an STA, an AP, an MLD) may transmit a request message indicating an information container, the information container including a set of one or more negotiation parameter sets (BA session parameter sets, one or more negotiation parameter sets 225 described herein with reference to FIG. 2). In addition, a negotiation parameter set of the one or more negotiation parameter sets may be associated with or indicated for a type of traffic such as a TID or a traffic flow. For example, a negotiation parameter set may be or may be associated with a TID-to-link mapping parameter set (one o more TID-to-link mapping parameter sets described herein with reference to FIG. 2). Each of the TID-to-link mapping parameter sets may include the information in the field format 400.

The field format 400 may include an element ID field 405 (one bit), a length field 410 (one bit), an element ID extension field 415 (one bit), a TID-to-link mapping control field 420 (1 or 2 bits), a mapping switch time 425 (0 or 2 bits), an expected duration field 430 (0 or 3 bits), an optional link mapping of TID0 field 435 (0, 1, or 2 bits), and an optional link mapping of TID7 field 445 (0, 1, or 2 bits). In addition, the field format 400 may include optional fields 440 indicating the link mapping of one or more of TID 1, TID2, TID3, TID4, TID5, or TID6 (each 0, 1, or 2 bits). As such, the field format 400 may indicate a link mapping for each TID associated with the session setup, and may correspond to a set of links for uplink links and a set of downlink links for each TID. The transmitting device may include the field format 400 in the information container to indicate the one or more TID-to-link mapping parameter sets associated with the negotiation of the session setup.

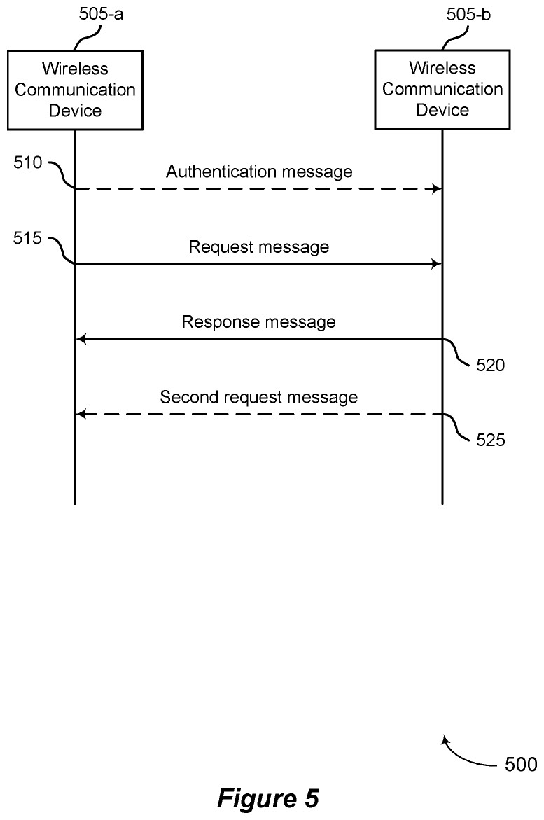

FIG. 5 shows an example of a process flow 500 that supports managing a multi-TID and multi-link BA negotiation scheme. The process flow 500 may implement aspects of wireless communication network 100 and the example process 200, or may be implemented by aspects of the wireless communication network 100 and the example process 200. For instance, the process flow 500 may illustrate operations between a wireless communication device 505-a and a wireless communication device 505-b, which may be examples of corresponding devices described herein. For example, the wireless communication devices 505 may represent examples of STAs 104, APs 102, or MLDs. In the following description of the process flow 500, the operations between the wireless communication device 505-a and the wireless communication device 505-b may be transmitted in a different order than the example order shown, or the operations performed by the wireless communication device 505-a and the wireless communication device 505-b may be performed in different orders or at different times. Some operations also may be omitted from the process flow 500, and other operations may be added to the process flow 500.

At 510, the wireless communication device 505-a may transmit, to the wireless communication device 505-b, an authentication message for authenticating the wireless communication device 505-b. The wireless communication device 505-a may authenticate the wireless communication device 505-b for negotiation of a particular setup session (for example, a BA setup session).

At 515, the wireless communication device 505-a may transmit, to the wireless communication device 505-b in association with the negotiation of the setup session, a request message that includes an information container (an information element), the information container including one or more negotiation parameter sets, at least one negotiation parameter set of the one or more negotiation parameter sets being associated with a type of traffic. For example, the type of traffic may correspond to a TID or a traffic flow. Each of the one or more negotiation parameter sets (for example, BA session parameter sets) may include a BA action, a dialog token, and parameters related to the BA setup session negotiation for each TID of one or more TIDs associated with the setup session. In some aspects, the at least one negotiation parameter set may be or may be associated with a TID-to-link mapping parameter set, which may indicate a mapping between each TID and one or more links (for example, uplinks and downlinks). In some aspects, the wireless communication device 505-a may include, in the request message, one or more negotiation parameter sets acceptable to the wireless communication device 505-a for the negotiation of the setup session. That is, the one or more acceptable negotiation parameters may be acceptable to the wireless communication device 505-a in examples in which the wireless communication device 505-b were to initiate the setup session negotiation and transmit a request message.

At 520, the wireless communication device 505-a may receive, from the wireless communication device 505-b in association with the negotiation of the setup session and in accordance with the request message, a response message that includes a set of values for one or more of the one or more negotiation parameter sets. For example, the response message may indicate an ACK of each of the one or more negotiation parameter sets. In some aspects, the response message may include a set of values or an ACK for a TID-to-link mapping parameter set.

At 525, the wireless communication device 505-a may receive, from the wireless communication device 505-b, a second request message including a second information container, the second information container including the one or more negotiation parameter sets acceptable to the wireless communication device 505-a, at least one second negotiation parameter set of the one or more second negotiation parameter sets may be associated with a type of traffic (for example, a TID or a traffic flow). Such a request message may reduce signaling overhead as the wireless communication device 505-a already accepts the one or more negotiation parameter sets.

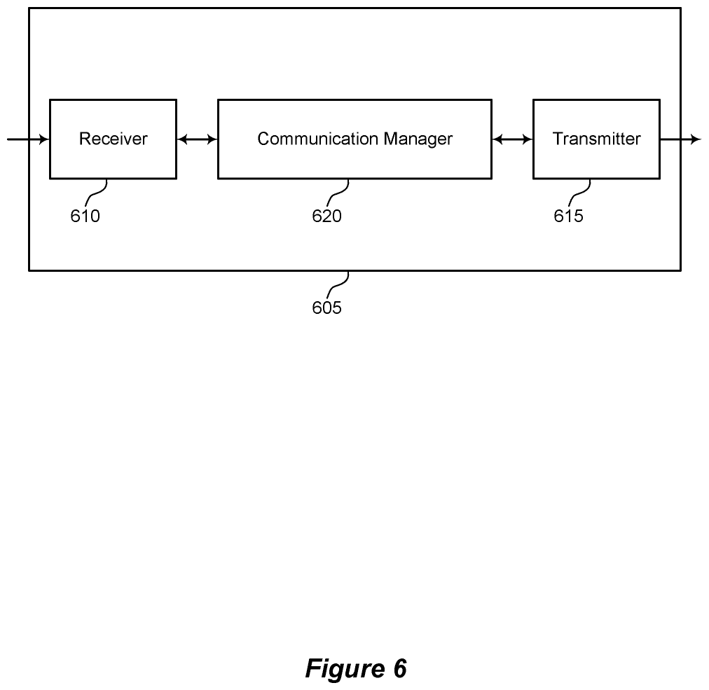

FIG. 6 shows a block diagram of a device 605 that supports managing a multi-TID and multi-link BA negotiation scheme in accordance with one or more aspects of the present disclosure. The device 605 may be an example of aspects of a STA as described herein. The device 605 may include a receiver 610, a transmitter 615, and a communication manager 620. The device 605, or one or more components of the device 605 (for example the receiver 610, the transmitter 615, and the communication manager 620), may include at least one processor, which may be coupled with at least one memory, to, individually or collectively, support or enable the described techniques. Each of these components may be in communication with one another (for example via one or more buses).

The receiver 610 may provide a means for receiving information such as packets, user data, control information, or any combination thereof associated with various information channels (for example control channels, data channels, information channels related to managing a multi-TID and multi-link BA negotiation scheme). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (for example control channels, data channels, information channels related to managing a multi-TID and multi-link BA negotiation scheme). In some aspects, the transmitter 615 may be co-located with a receiver 610 in a transceiver component. The transmitter 615 may utilize a single antenna or a set of multiple antennas.

The communication manager 620, the receiver 610, the transmitter 615, or various combinations thereof or various components thereof may be examples of means for performing various aspects of managing a multi-TID and multi-link BA negotiation scheme as described herein. For example, the communication manager 620, the receiver 610, the transmitter 615, or various combinations or components thereof may be capable of performing one or more of the functions described herein.

Additionally, or alternatively, the communication manager 620, the receiver 610, the transmitter 615, or various combinations or components thereof may be implemented in code (for example as communication management software or firmware) executed by at least one processor. If implemented in code executed by at least one processor, the functions of the communication manager 620, the receiver 610, the transmitter 615, or various combinations or components thereof may be performed by a general-purpose processor, a DSP, a CPU, an ASIC, an FPGA, a microcontroller, or any combination of these or other programmable logic devices (for example configured as or otherwise supporting, individually or collectively, a means for performing the functions described in the present disclosure).

In some aspects, the communication manager 620 may be configured to perform various operations (for example receiving, obtaining, monitoring, outputting, transmitting) using or otherwise in cooperation with the receiver 610, the transmitter 615, or both. For example, the communication manager 620 may receive information from the receiver 610, send information to the transmitter 615, or be integrated in combination with the receiver 610, the transmitter 615, or both to obtain information, output information, or perform various other operations as described herein.

The communication manager 620 may support wireless communication in accordance with examples as disclosed herein. For example, the communication manager 620 is capable of, configured to, or operable to support a means for transmitting, to a second wireless communication device in association with negotiation of a setup session, a request message that includes an information container including one or more negotiation parameter sets, at least one negotiation parameter set of the one or more negotiation parameter sets being associated with a type of traffic. The communication manager 620 is capable of, configured to, or operable to support a means for receiving, from the second wireless communication device in association with the negotiation of the setup session and in accordance with the request message, a response message that includes a set of values for one or more of the one or more negotiation parameter sets.

Additionally, or alternatively, the communication manager 620 may support wireless communication in accordance with examples as disclosed herein. For example, the communication manager 620 is capable of, configured to, or operable to support a means for receiving, from a second wireless communication device in association with negotiation of a setup session, a request message that includes an information container including one or more negotiation parameter sets, at least one negotiation parameter set of the one or more negotiation parameter sets being associated with a type of traffic. The communication manager 620 is capable of, configured to, or operable to support a means for transmitting, to the second wireless communication device in association with the negotiation of the setup session and in accordance with the request message, a response message that includes a set of values for one or more of the one or more negotiation parameter sets.

By including or configuring the communication manager 620 in accordance with examples as described herein, the device 605 (for example at least one processor controlling or otherwise coupled with the receiver 610, the transmitter 615, the communication manager 620, or a combination thereof) may support techniques for managing a multi-TID and multi-link BA negotiation scheme, which may reduce power consumption, reduce latency, improve signaling throughput, improve reliability, reduce signaling overhead, and improve negotiation efficiency.

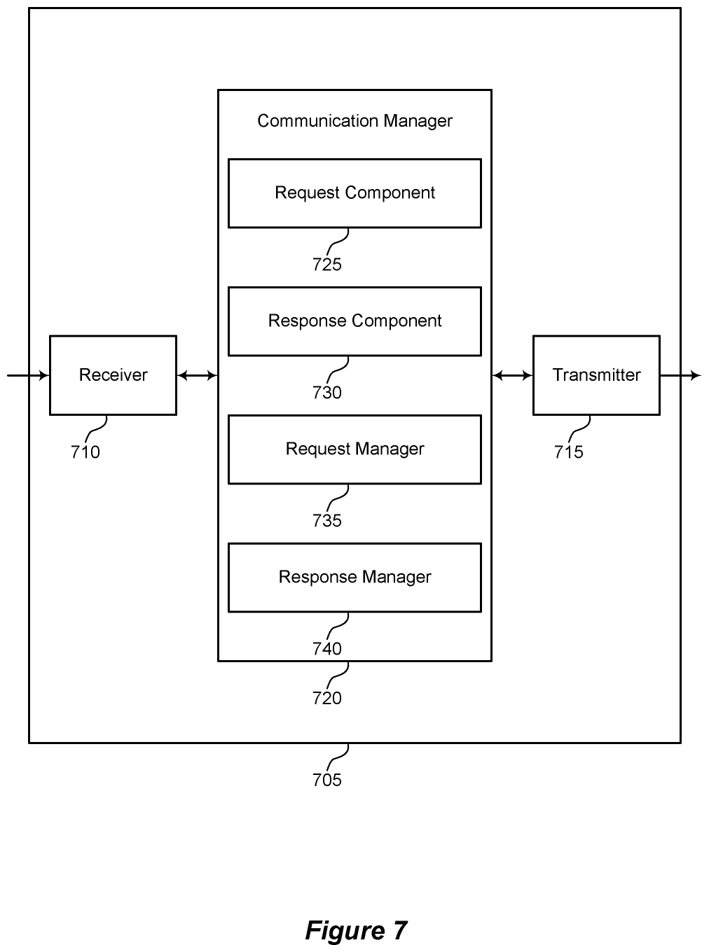

FIG. 7 shows a block diagram of a device 705 that supports managing a multi-TID and multi-link BA negotiation scheme in accordance with one or more aspects of the present disclosure. The device 705 may be an example of aspects of a device 605 or a STA 104 as described herein. The device 705 may include a receiver 710, a transmitter 715, and a communication manager 720. The device 705, or one of more components of the device 705 (for example the receiver 710, the transmitter 715, and the communication manager 720), may include at least one processor, which may be coupled with at least one memory, to support the described techniques. Each of these components may be in communication with one another (for example via one or more buses).

The receiver 710 may provide a means for receiving information such as packets, user data, control information, or any combination thereof associated with various information channels (for example control channels, data channels, information channels related to managing a multi-TID and multi-link BA negotiation scheme). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (for example control channels, data channels, information channels related to managing a multi-TID and multi-link BA negotiation scheme). In some aspects, the transmitter 715 may be co-located with a receiver 710 in a transceiver component. The transmitter 715 may utilize a single antenna or a set of multiple antennas.

The device 705, or various components thereof, may be an example of means for performing various aspects of managing a multi-TID and multi-link BA negotiation scheme as described herein. For example, the communication manager 720 may include a request component 725, a response component 730, a request manager 735, a response manager 740, or any combination thereof. The communication manager 720 may be an example of aspects of a communication manager 620 as described herein. In some aspects, the communication manager 720, or various components thereof, may be configured to perform various operations (for example receiving, obtaining, monitoring, outputting, transmitting) using or otherwise in cooperation with the receiver 710, the transmitter 715, or both. For example, the communication manager 720 may receive information from the receiver 710, send information to the transmitter 715, or be integrated in combination with the receiver 710, the transmitter 715, or both to obtain information, output information, or perform various other operations as described herein.

The communication manager 720 may support wireless communication in accordance with examples as disclosed herein. The request component 725 is capable of, configured to, or operable to support a means for transmitting, to a second wireless communication device in association with negotiation of a setup session, a request message that includes an information container including one or more negotiation parameter sets, at least one negotiation parameter set of the one or more negotiation parameter sets being associated with a type of traffic. The response component 730 is capable of, configured to, or operable to support a means for receiving, from the second wireless communication device in association with the negotiation of the setup session and in accordance with the request message, a response message that includes a set of values for one or more of the one or more negotiation parameter sets.

Additionally, or alternatively, the communication manager 720 may support wireless communication in accordance with examples as disclosed herein. The request manager 735 is capable of, configured to, or operable to support a means for receiving, from a second wireless communication device in association with negotiation of a setup session, a request message that includes an information container including one or more negotiation parameter sets, at least one negotiation parameter set of the one or more negotiation parameter sets being associated with a type of traffic. The response manager 740 is capable of, configured to, or operable to support a means for transmitting, to the second wireless communication device in association with the negotiation of the setup session and in accordance with the request message, a response message that includes a set of values for one or more of the one or more negotiation parameter sets.

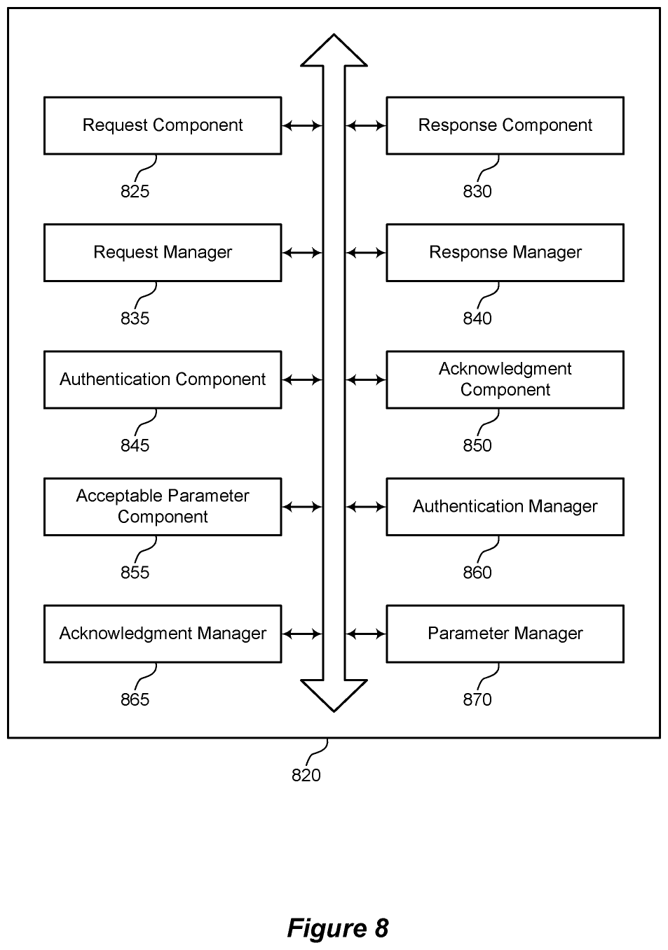

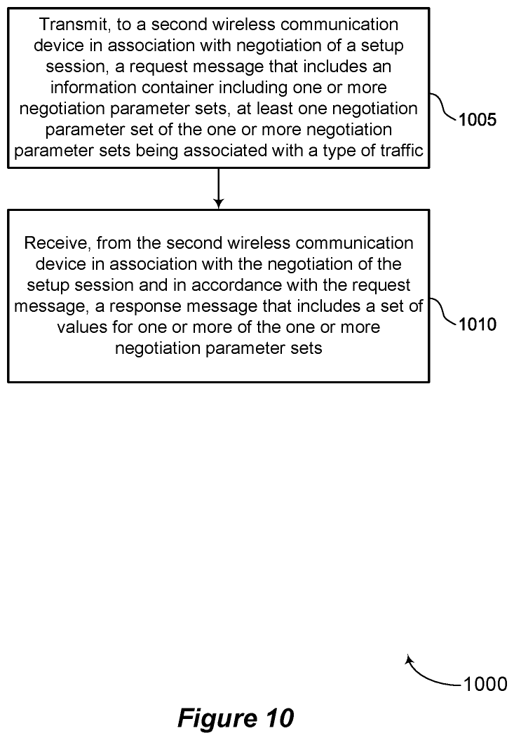

FIG. 8 shows a block diagram of an example wireless communication device that supports managing a multi-TID and multi-link BA negotiation scheme. In some aspects, the wireless communication device is configured to perform the processes 1000, 1100, 1200, and 1300 described with reference to FIGS. 10, 11, 12, and 13, respectively. The wireless communication device may include one or more chips, SoCs, chipsets, packages, components or devices that individually or collectively constitute or include a processing system. The processing system may interface with other components of the wireless communication device, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device may transmit the information output from the chip. In such an example, the second interface may refer to an interface between the processing system of the chip and a reception component, such that the wireless communication device may receive information that is then passed to the processing system. In some such examples, the first interface also may obtain information, such as from the transmission component, and the second interface also may output information, such as to the reception component.

The processing system of the wireless communication device includes processor (or “processing”) circuitry in the form of one or multiple processors, microprocessors, processing units (such as central processing units (CPUs), graphics processing units (GPUs) or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally or alternatively, in some implementations, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some aspects, the wireless communication device can configurable or configured for use in a communication manager 820, such as the AP 102 or the STA 104 described with reference to FIG. 1. In some other examples, the wireless communication device can be a communication manager 820 that includes such a processing system and other components including multiple antennas. The wireless communication device is capable of transmitting and receiving wireless communication in the form of, for example, wireless packets. For example, the wireless communication device can be configurable or configured to transmit and receive packets in the form of physical layer PPDUs and MPDUs conforming to one or more of the IEEE 802.11 family of wireless communication protocol standards. In some other examples, the wireless communication device can be configurable or configured to transmit and receive signals and communication conforming to one or more 3GPP specifications including those for 5G NR or 6G. In some aspects, the wireless communication device also includes or can be coupled with one or more application processors which may be further coupled with one or more other memories. In some aspects, the wireless communication device further includes a user interface (UI) (such as a touchscreen or keypad) and a display, which may be integrated with the UI to form a touchscreen display that is coupled with the processing system. In some aspects, the wireless communication device may further include one or more sensors such as, for example, one or more inertial sensors, accelerometers, temperature sensors, pressure sensors, or altitude sensors, that are coupled with the processing system. In some aspects, the wireless communication device further includes at least one external network interface coupled with the processing system that enables communication with a core network or backhaul network that enables the wireless communication device to gain access to external networks including the Internet.

The wireless communication device includes a request component 825, a response component 830, a request manager 835, a response manager 840, an authentication component 845, an ACK component 850, an acceptable parameter component 855, an authentication manager 860, an ACK manager 865, and a parameter manager 870. Portions of one or more of the request component 825, the response component 830, the request manager 835, the response manager 840, the authentication component 845, the ACK component 850, the acceptable parameter component 855, the authentication manager 860, the ACK manager 865, and the parameter manager 870 may be implemented at least in part in hardware or firmware. For example, one or more of the request component 825, the response component 830, the request manager 835, the response manager 840, the authentication component 845, the ACK component 850, the acceptable parameter component 855, the authentication manager 860, the ACK manager 865, and the parameter manager 870 may be implemented at least in part by at least a processor or a modem. In some aspects, portions of one or more of the request component 825, the response component 830, the request manager 835, the response manager 840, the authentication component 845, the ACK component 850, the acceptable parameter component 855, the authentication manager 860, the ACK manager 865, and the parameter manager 870 may be implemented at least in part by a processor and software in the form of processor-executable code stored in memory.

The wireless communication device may support wireless communication in accordance with examples as disclosed herein. The request component 825 is configurable or configured to transmit, to a second wireless communication device in association with negotiation of a setup session, a request message that includes an information container including one or more negotiation parameter sets, at least one negotiation parameter set of the one or more negotiation parameter sets being associated with a type of traffic. The response component 830 is configurable or configured to receive, from the second wireless communication device in association with the negotiation of the setup session and in accordance with the request message, a response message that includes a set of values for one or more of the one or more negotiation parameter sets.

In some aspects, each of the one or more negotiation parameter sets include one or more of a block acknowledgement session parameter set including a BA action that indicates whether a negotiation parameter set is associated with the request message or the response message, a dialog token, or one or more negotiation parameters corresponding to each respective TID of one or more TIDs.

In some aspects, the one or more negotiation parameters include one or more of a BA timeout value, a starting sequence number, or an add block acknowledge extension.

In some aspects, each of the one or more negotiation parameter sets include, for each TID of the one or more TIDs, an aggregation of the one or more negotiation parameters.

In some aspects, the at least one negotiation parameter set associated with the type of traffic includes a TID-to-link mapping parameter set.

In some aspects, the TID-to-link mapping parameter set indicates a mapping between each TID of one or more TIDs and one or more links associated with the setup session.

In some aspects, the authentication component 845 is configurable or configured to transmit an authentication message for authenticating the second wireless communication device, where transmitting the information container is in accordance with the authentication message.

In some aspects, to support receiving the response message, the ACK component 850 is configurable or configured to receive an ACK of each of the one or more negotiation parameter sets.

In some aspects, the request message further include a default negotiation parameter set and a default TID-to-link mapping.

In some aspects, the request component 825 is configurable or configured to transmit, to the second wireless communication device in association with renegotiation of the setup session and for each TID of one or more TIDs, a second request message that includes the information container, the information container including one or more second negotiation parameter sets, at least one second negotiation parameter set of the one or more second negotiation parameter sets being associated with a type of traffic. In some aspects, the response component 830 is configurable or configured to receive, from the second wireless communication device in association with the renegotiation of the setup session and in accordance with the second request message, a second response message that includes a second set of values for one or more of the one or more second negotiation parameter sets.

In some aspects, the acceptable parameter component 855 is configurable or configured to transmit, to the second wireless communication device via the request message, one or more negotiation parameter sets acceptable to the first wireless communication device for the negotiation of the setup session. In some aspects, the acceptable parameter component 855 is configurable or configured to receive, from the second wireless communication device, a second request message including a second information container, the second information container including the one or more negotiation parameter sets acceptable to the first wireless communication device.

In some aspects, each of the one or more negotiation parameter sets include one or more parameters that aid the second wireless communication device in selecting the set of values for one or more of the one or more negotiation parameter sets for inclusion in the response message.

In some aspects, the information container include one or more information elements according to a type of negotiation associated with the setup session.

In some aspects, the information container include one or more target wake time parameters and information corresponding to one or more links in accordance with a negotiation of a multi-link target wake time setup session.

In some aspects, the response message include a status indicator corresponding to each of the one or more negotiation parameter sets for inclusion in the response message. In some aspects, the status indicator indicate, for each TID of one or more TIDs, whether the negotiation is successful or fails.

In some aspects, the first wireless communication device include an AP, a STA, or a MLD. In some aspects, the second wireless communication device include an AP, a STA, or a MLD.

Additionally, or alternatively, the wireless communication device may support wireless communication in accordance with examples as disclosed herein. The request manager 835 is configurable or configured to receive, from a second wireless communication device in association with negotiation of a setup session, a request message that includes an information container including one or more negotiation parameter sets, at least one negotiation parameter set of the one or more negotiation parameter sets being associated with a type of traffic. The response manager 840 is configurable or configured to transmit, to the second wireless communication device in association with the negotiation of the setup session and in accordance with the request message, a response message that includes a set of values for one or more of the one or more negotiation parameter sets.

In some aspects, each of the one or more negotiation parameter sets include one or more of a block acknowledgement session parameter set including a BA action that indicates whether a negotiation parameter set is associated with the request message or the response message, a dialog token, or one or more negotiation parameters corresponding to each respective TID one or more TIDs.

In some aspects, the one or more negotiation parameters include one or more of a BA timeout value, a starting sequence number, or an add block acknowledge extension.

In some aspects, each of the one or more negotiation parameter sets include, for each TID of the one or more TIDs, an aggregation of the one or more negotiation parameters.

In some aspects, the at least one negotiation parameter set associated with the type of traffic includes a TID-to-link mapping parameter set.

In some aspects, the TID-to-link mapping parameter set indicates a mapping between each TID of one or more TIDs and one or more links associated with the setup session.

In some aspects, the authentication manager 860 is configurable or configured to receive an authentication message for authenticating the first wireless communication device, where receiving the information container is in accordance with the authentication message.

In some aspects, to support transmitting the response message, the ACK manager 865 is configurable or configured to transmit an ACK of each of the one or more negotiation parameter sets.

In some aspects, the request message further include a default negotiation parameter set and a default TID-to-link mapping.

In some aspects, the request manager 835 is configurable or configured to receive, from the second wireless communication device in association with renegotiation of the setup session and for each TID of one or more TIDs, a second request message that includes the information container, the information container including one or more second negotiation parameter sets, at least one second negotiation parameter set of the one or more second negotiation parameter sets being associated with a type of traffic. In some aspects, the response manager 840 is configurable or configured to transmit, to the second wireless communication device in association with the renegotiation of the setup session and in accordance with the second request message, a second response message that includes a second set of values for one or more of the one or more second negotiation parameter sets.

In some aspects, the parameter manager 870 is configurable or configured to receive, from the second wireless communication device via the request message, one or more negotiation parameter sets acceptable to the second wireless communication device for the negotiation of the setup session. In some aspects, the parameter manager 870 is configurable or configured to transmit, to the second wireless communication device, a second request message including a second information container, the second information container including the one or more negotiation parameter sets acceptable to the second wireless communication device.

In some aspects, each of the one or more negotiation parameter sets include one or more parameters that aid the first wireless communication device in selecting the set of values for one or more of the one or more negotiation parameter sets for inclusion in the response message.

In some aspects, the information container include one or more information elements according to a type of negotiation associated with the setup session.

In some aspects, the information container include one or more target wake time parameters and information corresponding to one or more links in accordance with a negotiation of a multi-link target wake time setup session.

In some aspects, the response message include a status indicator corresponding to each of the one or more negotiation parameter sets for inclusion in the response message. In some aspects, the status indicator indicate, for each TID of one or more TIDs, whether the negotiation is successful or fails.

In some aspects, the first wireless communication device include an AP, a STA, or a MLD. In some aspects, the second wireless communication device include an AP, a STA, or a MLD.

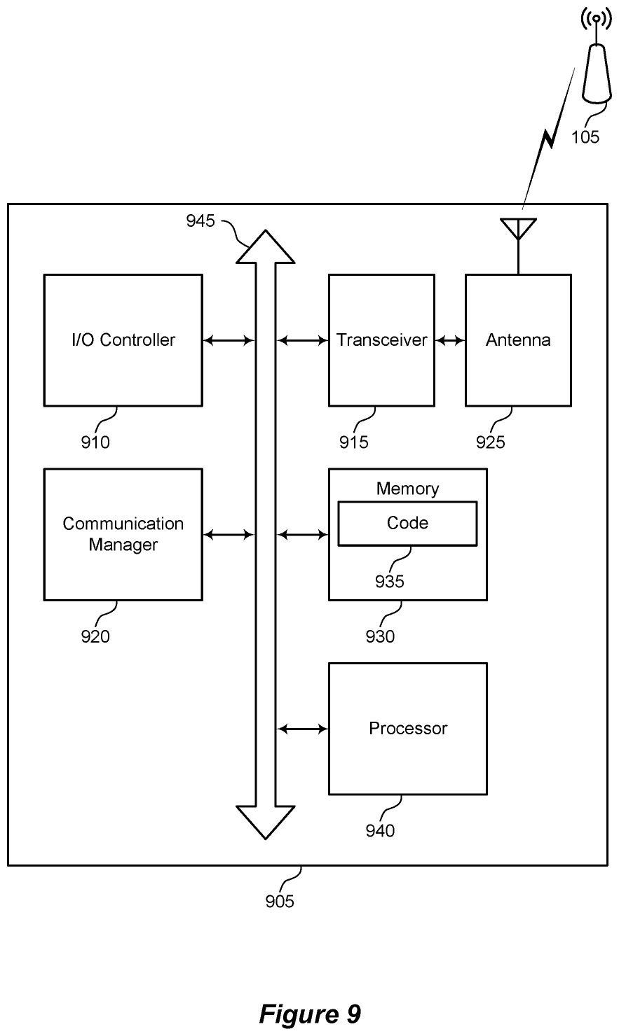

FIG. 9 shows a diagram of a system including a device 905 that supports managing a multi-TID and multi-link BA negotiation scheme in accordance with one or more aspects of the present disclosure. The device 905 may be an example of or include the components of a device 605, a device 705, or a STA as described herein. The device 905 may include components for bi-directional voice and data communication including components for transmitting and receiving communication, such as a communication manager 920, an I/O controller 910, a transceiver 915, an antenna 925, at least one memory 930, code 935, and at least one processor 940. These components may be in electronic communication or otherwise coupled (for example operatively, communicatively, functionally, electronically, electrically) via one or more buses (for example a bus 945).

The I/O controller 910 may manage input and output signals for the device 905. The I/O controller 910 also may manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. In some other cases, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 also may include a modem to modulate the packets and provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include RAM and ROM. The memory 930 may store computer-readable, computer-executable code 935 including instructions that, when executed by the processor 940, cause the device 905 to perform various functions described herein. In some cases, the memory 930 may contain, among other things, a BIOS which may control basic hardware or software operation such as the interaction with peripheral components or devices.

The processor 940 may include an intelligent hardware device, (for example a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (for example the memory 930) to cause the device 905 to perform various functions (for example functions or tasks supporting managing a multi-TID and multi-link BA negotiation scheme). For example, the device 905 or a component of the device 905 may include a processor 940 and memory 930 coupled to the processor 940, the processor 940 and memory 930 configured to perform various functions described herein.

The communication manager 920 may support wireless communication in accordance with examples as disclosed herein. For example, the communication manager 920 is capable of, configured to, or operable to support a means for transmitting, to a second wireless communication device in association with negotiation of a setup session, a request message that includes an information container including one or more negotiation parameter sets, at least one negotiation parameter set of the one or more negotiation parameter sets being associated with a type of traffic. The communication manager 920 is capable of, configured to, or operable to support a means for receiving, from the second wireless communication device in association with the negotiation of the setup session and in accordance with the request message, a response message that includes a set of values for one or more of the one or more negotiation parameter sets.

Additionally, or alternatively, the communication manager 920 may support wireless communication in accordance with examples as disclosed herein. For example, the communication manager 920 is capable of, configured to, or operable to support a means for receiving, from a second wireless communication device in association with negotiation of a setup session, a request message that includes an information container including one or more negotiation parameter sets, at least one negotiation parameter set of the one or more negotiation parameter sets being associated with a type of traffic. The communication manager 920 is capable of, configured to, or operable to support a means for transmitting, to the second wireless communication device in association with the negotiation of the setup session and in accordance with the request message, a response message that includes a set of values for one or more of the one or more negotiation parameter sets.

By including or configuring the communication manager 920 in accordance with examples as described herein, the device 905 may support techniques for managing a multi-TID and multi-link BA negotiation scheme, which may reduce power consumption, reduce latency, improve signaling throughput, improve reliability, reduce signaling overhead, and improve negotiation efficiency.

FIG. 10 shows a flowchart illustrating an example process 1000 performable by or at a first wireless communication device that supports managing a multi-TID and multi-link BA negotiation scheme. The operations of the process 1000 may be implemented by a first wireless communication device or its components as described herein. For example, the process 1000 may be performed by a wireless communication device, such as the wireless communication device described with reference to FIG. 8, operating as or within a wireless STA. In some aspects, the process 1000 may be performed by a wireless STA, such as one of the STAs 104 described with reference to FIG. 1.

In some aspects, in block 1005, the first wireless communication device may transmit, to a second wireless communication device in association with negotiation of a setup session, a request message that includes an information container including one or more negotiation parameter sets, at least one negotiation parameter set of the one or more negotiation parameter sets being associated with a type of traffic. The operations of block 1005 may be performed in accordance with examples as disclosed herein. In some implementations, aspects of the operations of block 1005 may be performed by a request component 825 as described with reference to FIG. 8.

In some aspects, in block 1010, the first wireless communication device may receive, from the second wireless communication device in association with the negotiation of the setup session and in accordance with the request message, a response message that includes a set of values for one or more of the one or more negotiation parameter sets. The operations of block 1010 may be performed in accordance with examples as disclosed herein. In some implementations, aspects of the operations of block 1010 may be performed by a response component 830 as described with reference to FIG. 8.

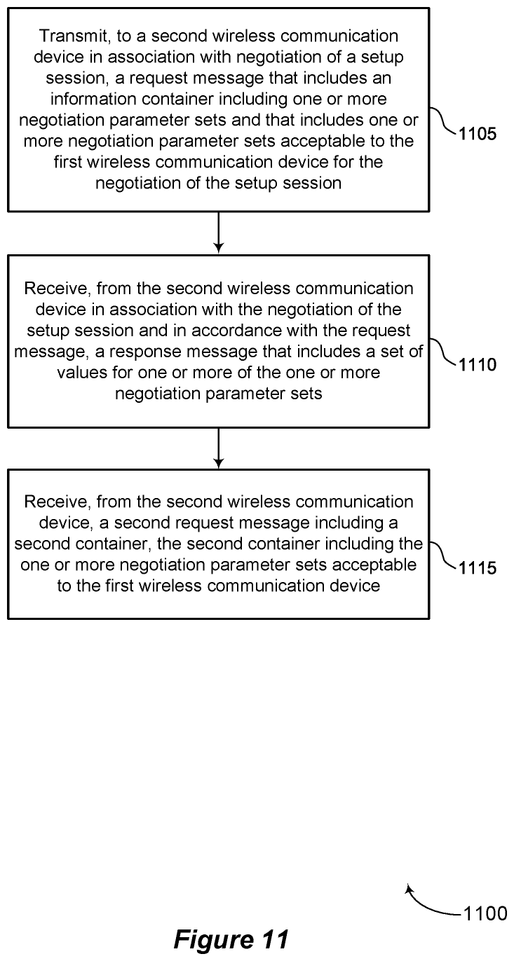

FIG. 11 shows a flowchart illustrating an example process 1100 performable by or at a first wireless communication device that supports managing a multi-TID and multi-link BA negotiation scheme. The operations of the process 1100 may be implemented by a first wireless communication device or its components as described herein. For example, the process 1100 may be performed by a wireless communication device, such as the wireless communication device described with reference to FIG. 8, operating as or within a wireless STA. In some aspects, the process 1100 may be performed by a wireless STA, such as one of the STAs 104 described with reference to FIG. 1.

In some aspects, in block 1105, the first wireless communication device may transmit, to a second wireless communication device in association with negotiation of a setup session, a request message that includes an information container including one or more negotiation parameter sets and that includes one or more negotiation parameter sets acceptable to the first wireless communication device for the negotiation of the setup session. The operations of block 1105 may be performed in accordance with examples as disclosed herein. In some implementations, aspects of the operations of block 1105 may be performed by a request component 825 as described with reference to FIG. 8.

In some aspects, in block 1110, the first wireless communication device may receive, from the second wireless communication device in association with the negotiation of the setup session and in accordance with the request message, a response message that includes a set of values for one or more of the one or more negotiation parameter sets. The operations of block 1110 may be performed in accordance with examples as disclosed herein. In some implementations, aspects of the operations of block 1110 may be performed by a response component 830 as described with reference to FIG. 8.

In some aspects, in block 1115, the first wireless communication device may receive, from the second wireless communication device, a second request message including a second information container, the second information container including the one or more negotiation parameter sets acceptable to the first wireless communication device. The operations of block 1115 may be performed in accordance with examples as disclosed herein. In some implementations, aspects of the operations of block 1115 may be performed by an acceptable parameter component 855 as described with reference to FIG. 8.

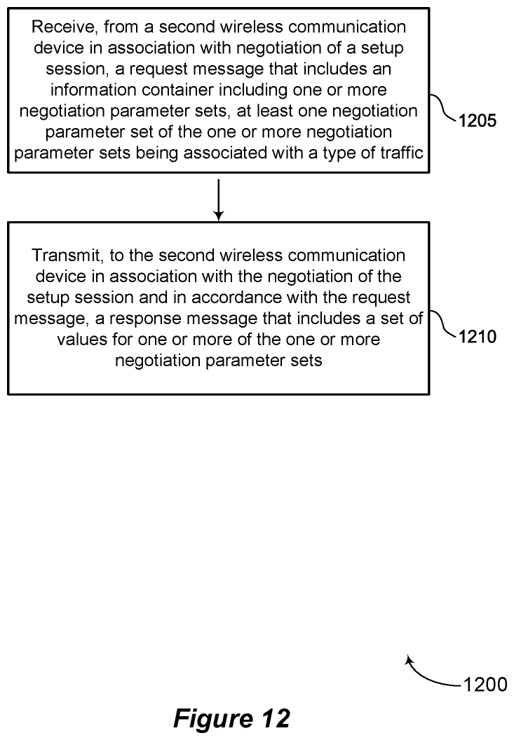

FIG. 12 shows a flowchart illustrating an example process 1200 performable by or at a first wireless communication device that supports managing a multi-TID and multi-link BA negotiation scheme. The operations of the process 1200 may be implemented by a first wireless communication device or its components as described herein. For example, the process 1200 may be performed by a wireless communication device, such as the wireless communication device described with reference to FIG. 8, operating as or within a wireless STA. In some aspects, the process 1200 may be performed by a wireless STA, such as one of the STAs 104 described with reference to FIG. 1.

In some aspects, in block 1205, the first wireless communication device may receive, from a second wireless communication device in association with negotiation of a setup session, a request message that includes an information container including one or more negotiation parameter sets, at least one negotiation parameter set of the one or more negotiation parameter sets being associated with a type of traffic. The operations of block 1205 may be performed in accordance with examples as disclosed herein. In some implementations, aspects of the operations of block 1205 may be performed by a request manager 835 as described with reference to FIG. 8.

In some aspects, in block 1210, the first wireless communication device may transmit, to the second wireless communication device in association with the negotiation of the setup session and in accordance with the request message, a response message that includes a set of values for one or more of the one or more negotiation parameter sets. The operations of block 1210 may be performed in accordance with examples as disclosed herein. In some implementations, aspects of the operations of block 1210 may be performed by a response manager 840 as described with reference to FIG. 8.

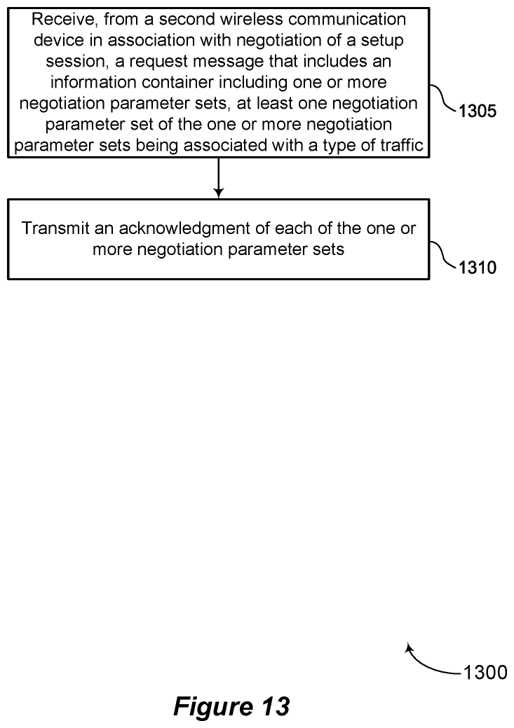

FIG. 13 shows a flowchart illustrating an example process 1300 performable by or at a first wireless communication device that supports managing a multi-TID and multi-link BA negotiation scheme. The operations of the process 1300 may be implemented by a first wireless communication device or its components as described herein. For example, the process 1300 may be performed by a wireless communication device, such as the wireless communication device described with reference to FIG. 8, operating as or within a wireless STA. In some aspects, the process 1300 may be performed by a wireless STA, such as one of the STAs 104 described with reference to FIG. 1.

In some aspects, in block 1305, the first wireless communication device may receive, from a second wireless communication device in association with negotiation of a setup session, a request message that includes an information container including one or more negotiation parameter sets, at least one negotiation parameter set of the one or more negotiation parameter sets being associated with a type of traffic. The operations of block 1305 may be performed in accordance with examples as disclosed herein. In some implementations, aspects of the operations of block 1305 may be performed by a request manager 835 as described with reference to FIG. 8.

In some aspects, in block 1310, the first wireless communication device may transmit an ACK of each of the one or more negotiation parameter sets. The operations of block 1310 may be performed in accordance with examples as disclosed herein. In some implementations, aspects of the operations of block 1310 may be performed by an ACK manager 865 as described with reference to FIG. 8.

Implementation examples are described in the following numbered clauses:

The following provides an overview of aspects of the present disclosure:

Aspect 1: A method for wireless communication by a first wireless communication device, comprising: transmitting, to a second wireless communication device in association with negotiation of a setup session, a request message that includes an information container including one or more negotiation parameter sets, at least one negotiation parameter set of the one or more negotiation parameter sets being associated with a type of traffic; and receiving, from the second wireless communication device in association with the negotiation of the setup session and in accordance with the request message, a response message that includes a set of values for one or more of the one or more negotiation parameter sets.

Aspect 2: The method of aspect 1, wherein each of the one or more negotiation parameter sets includes one or more of a block acknowledgement session parameter set comprising a block ACK action that indicates whether a negotiation parameter set is associated with the request message or the response message, a dialog token, or one or more negotiation parameters corresponding to each respective TID of one or more TIDs.

Aspect 3: The method of aspect 2, wherein the one or more negotiation parameters comprise one or more of a block ACK timeout value, a starting sequence number, or an add block acknowledge extension.

Aspect 4: The method of any of aspects 2 through 3, wherein each of the one or more negotiation parameter sets includes, for each TID of the one or more TIDs, an aggregation of the one or more negotiation parameters.

Aspect 5: The method of any of aspects 1 through 4, wherein the at least one negotiation parameter set associated with the type of traffic includes a TID-to-link mapping parameter set.

Aspect 6: The method of aspect 5, wherein the TID-to-link mapping parameter set indicates a mapping between each TID of one or more TIDs and one or more links associated with the setup session.

Aspect 7: The method of any of aspects 1 through 6, further comprising: transmitting an authentication message for authenticating the second wireless communication device, wherein transmitting the information container is in accordance with the authentication message.

Aspect 8: The method of any of aspects 1 through 7, wherein receiving the response message comprises: receiving an ACK of each of the one or more negotiation parameter sets or the one or more TID-to-link mapping parameter sets.

Aspect 9: The method of any of aspects 1 through 8, wherein the request message further comprises a default negotiation parameter set and a default TID-to-link mapping.

Aspect 10: The method of any of aspects 1 through 9, further comprising: transmitting, to the second wireless communication device in association with renegotiation of the setup session and for each TID of one or more TIDs, a second request message that includes the information container, the information container including one or more second negotiation parameter sets, at least one second negotiation parameter set of the one or more second negotiation parameter sets being associated with a type of traffic; and receiving, from the second wireless communication device in association with the renegotiation of the setup session and in accordance with the second request message, a second response message that includes a second set of values for one or more of the one or more second negotiation parameter sets.

Aspect 11: The method of any of aspects 1 through 10, further comprising: transmitting, to the second wireless communication device via the request message, one or more negotiation parameter sets acceptable to the first wireless communication device for the negotiation of the setup session; and receiving, from the second wireless communication device, a second request message comprising a second information container, the second information container including the one or more negotiation parameter sets acceptable to the first wireless communication device.

Aspect 12: The method of any of aspects 1 through 11, wherein each of the one or more negotiation parameter sets includes one or more parameters that aid the second wireless communication device in selecting the set of values for one or more of the one or more negotiation parameter sets for inclusion in the response message.

Aspect 13: The method of any of aspects 1 through 12, wherein the information container comprises one or more information elements according to a type of negotiation associated with the setup session.

Aspect 14: The method of aspect 13, wherein the information container comprises one or more TWT parameters and information corresponding to one or more links in accordance with a negotiation of a multi-link TWT setup session.

Aspect 15: The method of any of aspects 1 through 14, wherein the response message includes a status indicator corresponding to each of the one or more negotiation parameter sets for inclusion in the response message, the status indicator indicates, for each TID of one or more TIDs, whether the negotiation is successful or fails.

Aspect 16: The method of any of aspects 1 through 15, wherein the first wireless communication device comprises an AP, a STA, or an MLD, and the second wireless communication device comprises an AP, a STA, or an MLD.

Aspect 17: A method for wireless communication by a first wireless communication device, comprising: receiving, from a second wireless communication device in association with negotiation of a setup session, a request message that includes an information container including one or more negotiation parameter sets, at least one negotiation parameter set of the one or more negotiation parameter sets being associated with a type of traffic; and transmitting, to the second wireless communication device in association with the negotiation of the setup session and in accordance with the request message, a response message that includes a set of values for one or more of the one or more negotiation parameter sets.

Aspect 18: The method of aspect 17, wherein each of the one or more negotiation parameter sets includes one or more of a block acknowledgement session parameter set comprising a block ACK action that indicates whether a negotiation parameter set is associated with the request message or the response message, a dialog token, or one or more negotiation parameters corresponding to each respective TID one or more TIDs.

Aspect 19: The method of aspect 18, wherein the one or more negotiation parameters comprise one or more of a block ACK timeout value, a starting sequence number, or an add block acknowledge extension.

Aspect 20: The method of any of aspects 18 through 19, wherein each of the one or more negotiation parameter sets includes, for each TID of the one or more TIDS, an aggregation of the one or more negotiation parameters.

Aspect 21: The method of any of aspects 17 through 20, wherein the at least one negotiation parameter set associated with the type of traffic includes a TID-to-link mapping parameter set.

Aspect 22: The method of aspect 21, wherein the TID-to-link mapping parameter set indicates a mapping between each TID of one or more TIDs and one or more links associated with the setup session.

Aspect 23: The method of any of aspects 17 through 22, further comprising: receiving an authentication message for authenticating the first wireless communication device, wherein receiving the information container is in accordance with the authentication message.

Aspect 24: The method of any of aspects 17 through 23, wherein transmitting the response message comprises: transmitting an ACK of each of the one or more negotiation parameter sets or the one or more TID-to-link mapping parameter sets.

Aspect 25: The method of any of aspects 17 through 24, wherein the request message further comprises a default negotiation parameter set and a default TID-to-link mapping.

Aspect 26: The method of any of aspects 17 through 25, further comprising: receiving, from the second wireless communication device in association with renegotiation of the setup session and for each TID of one or more TIDs, a second request message that includes the information container, the information container including one or more second negotiation parameter sets, at least one second negotiation parameter set of the one or more second negotiation parameter sets being associated with a type of traffic; and transmitting, to the second wireless communication device in association with the renegotiation of the setup session and in accordance with the second request message, a second response message that includes a second set of values for one or more of the one or more second negotiation parameter sets.

Aspect 27: The method of any of aspects 17 through 26, further comprising: receiving, from the second wireless communication device via the request message, one or more negotiation parameter sets acceptable to the second wireless communication device for the negotiation of the setup session; and transmitting, to the second wireless communication device, a second request message comprising a second information container, the second information container including the one or more negotiation parameter sets acceptable to the second wireless communication device.

Aspect 28: The method of any of aspects 17 through 27, wherein each of the one or more negotiation parameter sets includes one or more parameters that aid the first wireless communication device in selecting the set of values for one or more of the one or more negotiation parameter sets for inclusion in the response message.

Aspect 29: The method of any of aspects 17 through 28, wherein the information container comprises one or more information elements according to a type of negotiation associated with the setup session.

Aspect 30: The method of aspect 29, wherein the information container comprises one or more TWT parameters and information corresponding to one or more links in accordance with a negotiation of a multi-link TWT setup session.

Aspect 31: The method of any of aspects 17 through 30, wherein the response message includes a status indicator corresponding to each of the one or more negotiation parameter sets for inclusion in the response message, the status indicator indicates, for each TID of one or more TIDs, whether the negotiation is successful or fails.

Aspect 32: The method of any of aspects 17 through 31, wherein the first wireless communication device comprises an AP, a STA, or an MLD, and the second wireless communication device comprises an AP, a STA, or an MLD.

Aspect 33: A first wireless communication device for wireless communication, comprising a processing system that includes processor circuitry and memory circuitry that stores code, the processing system configured to cause the first wireless communication device to perform a method of any of aspects 1 through 16.

Aspect 34: A first wireless communication device for wireless communication, comprising at least one means for performing a method of any of aspects 1 through 16.

Aspect 35: A non-transitory computer-readable medium storing code for wireless communication, the code comprising instructions executable by a processor to perform a method of any of aspects 1 through 16.

Aspect 36: A first wireless communication device for wireless communication, comprising a processing system that includes processor circuitry and memory circuitry that stores code, the processing system configured to cause the first wireless communication device to perform a method of any of aspects 17 through 32.

Aspect 37: A first wireless communication device for wireless communication, comprising at least one means for performing a method of any of aspects 17 through 32.

Aspect 38: A non-transitory computer-readable medium storing code for wireless communication, the code comprising instructions executable by a processor to perform a method of any of aspects 17 through 32.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some implementations be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A first wireless communication device, comprising:
a processing system that includes processor circuitry and memory circuitry that stores code, the processing system configured to cause the first wireless communication device to:
transmit, to a second wireless communication device in association with negotiation of a setup session, a request message that includes an information container including one or more negotiation parameter sets and one or more traffic identifier-to-link mapping parameter sets; and
receive, from the second wireless communication device in association with the negotiation of the setup session and in accordance with the request message, a response message that includes a set of values for one or more of the one or more negotiation parameter sets or the one or more traffic identifier-to-link mapping parameter sets.

2. The first wireless communication device of claim 1, wherein each of the one or more negotiation parameter sets includes one or more of a block acknowledgement session parameter set comprising a block acknowledgment action that indicates whether a negotiation parameter set is associated with the request message or the response message, a dialog token, or one or more negotiation parameters corresponding to each respective traffic identifier of one or more traffic identifiers.

3. The first wireless communication device of claim 2, wherein the one or more negotiation parameters comprise one or more of a block acknowledgment timeout value, a starting sequence number, or an add block acknowledge extension.

4. The first wireless communication device of claim 2, wherein each of the one or more negotiation parameter sets includes, for each traffic identifier of the one or more traffic identifiers, an aggregation of the one or more negotiation parameters.

5. The first wireless communication device of claim 1, wherein each traffic identifier-to-link mapping parameter set of the one or more traffic identifier-to-link mapping parameter sets indicates a mapping between each traffic identifier of one or more traffic identifiers and one or more links associated with the setup session.

6. The first wireless communication device of claim 1, wherein the processing system is further configured to cause the first wireless communication device to:
transmit an authentication message for authenticating the second wireless communication device, wherein transmitting the information container is in accordance with the authentication message.

7. The first wireless communication device of claim 1, wherein, to receive the response message, the processing system is configured to cause the first wireless communication device to:
receive an acknowledgment of each of the one or more negotiation parameter sets or the one or more traffic identifier-to-link mapping parameter sets.

8. The first wireless communication device of claim 1, wherein the request message further comprises a default negotiation parameter set and a default traffic identifier-to-link mapping.

9. The first wireless communication device of claim 1, wherein the processing system is further configured to cause the first wireless communication device to:
transmit, to the second wireless communication device in association with renegotiation of the setup session and for each traffic identifier of one or more traffic identifiers, a second request message that includes the information container, the information container including one or more second negotiation parameter sets and one or more second traffic identifier-to-link mapping parameter sets; and
receive, from the second wireless communication device in association with the renegotiation of the setup session and in accordance with the second request message, a second response message that includes a second set of values for one or more of the one or more second negotiation parameter sets or the one or more second traffic identifier-to-link mapping parameter sets.

10. The first wireless communication device of claim 1, wherein the processing system is further configured to cause the first wireless communication device to:
transmit, to the second wireless communication device via the request message, one or more negotiation parameter sets acceptable to the first wireless communication device for the negotiation of the setup session; and
receive, from the second wireless communication device, a second request message comprising a second container, the second container including the one or more negotiation parameter sets acceptable to the first wireless communication device and the one or more traffic identifier-to-link mapping parameter sets.

11. The first wireless communication device of claim 1, wherein each of the one or more negotiation parameter sets includes one or more parameters that aid the second wireless communication device in selecting the set of values for one or more of the one or more negotiation parameter sets or the one or more traffic identifier-to-link mapping parameter sets for inclusion in the response message.

12. The first wireless communication device of claim 1, wherein the information container comprises one or more information elements according to a type of negotiation associated with the setup session.

13. The first wireless communication device of claim 12, wherein the information container comprises one or more target wake time parameters and information corresponding to one or more links in accordance with a negotiation of a multi-link target wake time setup session.

14. The first wireless communication device of claim 1, wherein:
the response message includes a status indicator corresponding to each of the one or more negotiation parameter sets or the one or more traffic identifier-to-link mapping parameter sets for inclusion in the response message, the status indicator indicating, for each traffic identifier of one or more traffic identifiers, whether the negotiation is successful or fails.

15. The first wireless communication device of claim 1, wherein:
the first wireless communication device comprises an access point, a station, or a multi-link device, and
the second wireless communication device comprises an access point, a station, or a multi-link device.

16. A first wireless communication device, comprising:
a processing system that includes processor circuitry and memory circuitry that stores code, the processing system configured to cause the first wireless communication device to:
receive, from a second wireless communication device in association with negotiation of a setup session, a request message that includes an information container including one or more negotiation parameter sets and one or more traffic identifier-to-link mapping parameter sets; and
transmit, to the second wireless communication device in association with the negotiation of the setup session and in accordance with the request message, a response message that includes a set of values for one or more of the one or more negotiation parameter sets or the one or more traffic identifier-to-link mapping parameter sets.

17. The first wireless communication device of claim 16, wherein each of the one or more negotiation parameter sets includes one or more of a block acknowledgement session parameter set comprising a block acknowledgment action that indicates whether a negotiation parameter set is associated with the request message or the response message, a dialog token, or one or more negotiation parameters corresponding to each respective traffic identifier one or more traffic identifiers.

18. The first wireless communication device of claim 17, wherein the one or more negotiation parameters comprise one or more of a block acknowledgment timeout value, a starting sequence number, or an add block acknowledge extension.

19. The first wireless communication device of claim 17, wherein each of the one or more negotiation parameter sets includes, for each traffic identifier of the one or more traffic identifiers, an aggregation of the one or more negotiation parameters.

20. The first wireless communication device of claim 16, wherein each traffic identifier-to-link mapping parameter set of the one or more traffic identifier-to-link mapping parameter sets indicates a mapping between each traffic identifier of one or more traffic identifiers and one or more links associated with the setup session.

21. The first wireless communication device of claim 16, wherein the processing system is further configured to cause the first wireless communication device to:
receive an authentication message for authenticating the first wireless communication device, wherein receiving the information container is in accordance with the authentication message.

22. The first wireless communication device of claim 16, wherein, to transmit the response message, the processing system is configured to cause the first wireless communication device to:
transmit an acknowledgment of each of the one or more negotiation parameter sets or the one or more traffic identifier-to-link mapping parameter sets.

23. The first wireless communication device of claim 16, wherein the request message further comprises a default negotiation parameter set and a default traffic identifier-to-link mapping.

24. The first wireless communication device of claim 16, wherein the processing system is further configured to cause the first wireless communication device to:
receive, from the second wireless communication device in association with renegotiation of the setup session and for each traffic identifier of one or more traffic identifiers, a second request message that includes the information container, the information container including one or more second negotiation parameter sets and one or more second traffic identifier-to-link mapping parameter sets; and
transmit, to the second wireless communication device in association with the renegotiation of the setup session and in accordance with the second request message, a second response message that includes a second set of values for one or more of the one or more second negotiation parameter sets or the one or more second traffic identifier-to-link mapping parameter sets.

25. The first wireless communication device of claim 16, wherein the processing system is further configured to cause the first wireless communication device to:
receive, from the second wireless communication device via the request message, one or more negotiation parameter sets acceptable to the second wireless communication device for the negotiation of the setup session; and
transmit, to the second wireless communication device, a second request message comprising a second container, the second container including the one or more negotiation parameter sets acceptable to the second wireless communication device and the one or more traffic identifier-to-link mapping parameter sets.

26. The first wireless communication device of claim 16, wherein each of the one or more negotiation parameter sets includes one or more parameters that aid the first wireless communication device in selecting the set of values for one or more of the one or more negotiation parameter sets or the one or more traffic identifier-to-link mapping parameter sets for inclusion in the response message.

27. The first wireless communication device of claim 16, wherein the information container comprises one or more information elements according to a type of negotiation associated with the setup session.

28. The first wireless communication device of claim 27, wherein the information container comprises one or more target wake time parameters and information corresponding to one or more links in accordance with a negotiation of a multi-link target wake time setup session.

29. A method for wireless communication by a first wireless communication device, comprising:
transmitting, to a second wireless communication device in association with negotiation of a setup session, a request message that includes an information container including one or more negotiation parameter sets, at least one negotiation parameter set of the one or more negotiation parameter sets being associated with a type of traffic; and
receiving, from the second wireless communication device in association with the negotiation of the setup session and in accordance with the request message, a response message that includes a set of values for one or more of the one or more negotiation parameter sets.

30. A method for wireless communication by a first wireless communication device, comprising:
receiving, from a second wireless communication device in association with negotiation of a setup session, a request message that includes an information container including one or more negotiation parameter sets, at least one negotiation parameter set of the one or more negotiation parameter sets being associated with a type of traffic; and
transmitting, to the second wireless communication device in association with the negotiation of the setup session and in accordance with the request message, a response message that includes a set of values for one or more of the one or more negotiation parameter sets.
